(19) United States
(12) Patent Application Publication
(10) Pub. No.: US 2004/0086755 A1
(43) Pub. Date: May 6, 2004

(54) Portable fuel cell system

(75) Inventor: Peter J. Kalal, Corning, NY (US)

Correspondence Address: CORNING INCORPORATED, SP-TI-3-1, CORNING, NY, 14831

(73) Assignee: Corning Incorporated

(21) Appl. No.: 10/283,986

(22) Filed: Oct. 30, 2002

(51) Int. Cl. H01M 8/06

(52) U.S. Cl. 429/19; 429/21; 429/17; 429/34

(57) ABSTRACT

A portable fuel cell system and methods for making and using the portable fuel cell system are described herein. In one embodiment, the portable fuel cell system includes a hydrogen generation unit (i.e., electrolyzer), a hydrogen storage unit (e.g., metal hydride storage vessel) and a fuel cell (e.g., SPE fuel cell). The hydrogen generation unit is attachable to and detachable from the hydrogen storage unit. The hydrogen storage unit is also attachable to and detachable from the fuel cell. And, the fuel cell is attachable to and detachable from a portable electrical device (e.g., cell phone, personal digital assistant, laptop computer, flashlight). In operation, the hydrogen generation unit generates hydrogen that is stored in the hydrogen storage unit. The fuel cell then uses the stored hydrogen to generate electricity that powers the portable electrical device.

### BACKGROUND OF THE INVENTION

1. Field of the Invention

The present invention relates to a portable fuel cell system that includes a hydrogen generation unit, a hydrogen storage unit and a fuel cell.

2. Description of Related Art

Portable electrical devices (e.g., cell phones, personal digital assistants, laptop computers) demand a significant amount of electricity to operate. Batteries such as Li-ion, Li-polymer, Nickel-Cadmium or Nickel-Metal Hydride and other secondary (rechargeable) battery systems are used today to supply electricity to portable electrical devices. However, it is generally accepted that these power sources are going to reach their performance limits in the next few years. As such, these power sources may not be able to power the next generation of portable electrical devices which are going to demand even more electricity to operate than traditional portable electrical devices. It is also generally accepted that fuel cells are the only viable alternative to these power sources which are going to be able to power the next generation of portable electrical devices. Unfortunately, there does not appear to be a portable fuel cell system including a fuel cell and other necessary components in the market place which makes it easy and convenient for a user to power the next generation portable electrical devices. In fact, there does not appear to be a portable fuel cell system including a fuel cell and other necessary components in the market place which makes it easy and convenient for a user to power traditional portable electrical devices. Accordingly, there is a need for a portable fuel cell system that includes all of the necessary components which makes it easy and convenient for a user to power the next generation of portable electrical devices and traditional portable electrical devices. This need and other needs are satisfied by the portable fuel cell system and methods of the present invention.

### BRIEF DESCRIPTION OF THE INVENTION

The present invention includes a portable fuel cell system and methods for making and using the portable fuel cell system. In one embodiment, the portable fuel cell system includes a hydrogen generation unit (i.e., electrolyzer), a hydrogen storage unit (e.g., metal hydride storage vessel) and a fuel cell (e.g., SPE fuel cell). The hydrogen generation unit is attachable to and detachable from the hydrogen storage unit. The hydrogen storage unit is also attachable to and detachable from the fuel cell. And, the fuel cell is attachable to and detachable from a portable electrical device (e.g., cell phone, personal digital assistant, laptop computer, flashlight). In operation, the hydrogen generation unit generates hydrogen that is stored in the hydrogen storage unit. The fuel cell then uses the stored hydrogen to generate electricity that powers the portable electrical device.

### BRIEF DESCRIPTION OF THE DRAWINGS

A more complete understanding of the present invention may be had by reference to the following detailed description when taken in conjunction with the accompanying drawings wherein:

FIG. 1 is a block diagram illustrating the basic components of a preferred embodiment of a portable fuel cell system in accordance with the present invention;

FIG. 2 is a flowchart illustrating the steps of a preferred method for making the portable fuel cell system in accordance with the present invention; and

FIG. 3 is a flowchart illustrating the steps of a preferred method for using the portable fuel cell system in accordance with the present invention.

### DETAILED DESCRIPTION OF THE DRAWINGS

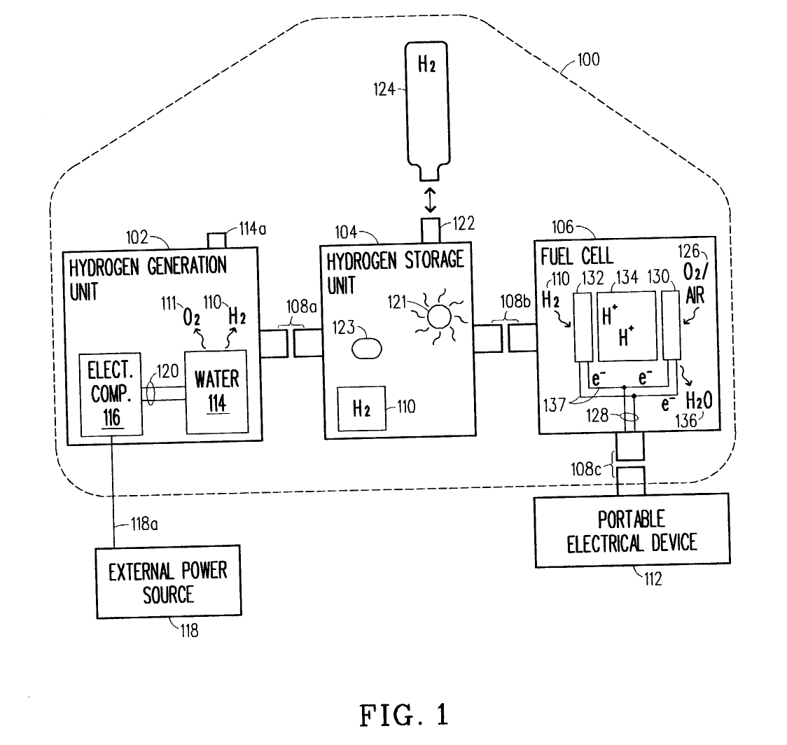

Referring to FIGS. 1-3, there are disclosed in accordance with the present invention a portable fuel cell system 100 and methods 200 and 300 for making and using the portable fuel cell system 100. Although the portable fuel cell system 100 is described below as using a solid polymer electrolyte (SPE) fuel cell, it should be understood that different types of fuel cells can be used such as alkaline fuel cells, phosphoric acid fuel cells and solid oxide fuel cells. Accordingly, the portable fuel cell system 100 and methods 200 and 300 for making and using the portable fuel cell system 100 should not be construed in a limited manner.

Referring to FIG. 1, there is a block diagram illustrating the basic components of the portable fuel cell system 100. As shown, the portable fuel cell system 100 includes a hydrogen generation unit 102, a hydrogen storage unit 104 and a SPE fuel cell 106. The hydrogen generation unit 102 is attachable to and detachable from the hydrogen storage unit 104 using a pair of connectors 108a. The hydrogen storage unit 104 is also attachable to and detachable from the SPE fuel cell 106 using a pair of connectors 108b. And, the SPE fuel cell 106 is attachable to and detachable from a portable electrical device 112 using a pair of connectors 108c. The pair of connectors 108a, 108b and 108c can be anyone of a variety of fasteners including, for example, snap-fit connectors, pin-slot connectors and screw/nut connectors. Basically, the hydrogen generation unit 102 generates hydrogen 110 (e.g., fuel) that is stored in the hydrogen storage unit 104. The SPE fuel cell 106 then uses the stored hydrogen 110 to generate electricity 128 that powers a portable electrical device 112. The portable electrical device 112 can be a cell phone, a personal digital assistant (PDA), a laptop computer, a digital camera, a game device, a portable television, a small heater, a flashlight or other electrical device. Each of the components in the portable fuel cell system 100 is described in greater detail below.

The hydrogen generation unit 102 in the preferred embodiment is an electrolyzer 102 that can be used to electrolyze, split, decompose water 114 into hydrogen 110 and oxygen 111. To accomplish this electrochemical decomposition/electrolysis of water 114 into hydrogen 110 and oxygen 111, the user needs to connect the electrolyzer 102 and in particular electrical components 116 located therein to an external power source 118 (e.g., household power outlet, car power outlet, battery, solar panel, another fuel cell). The electrical components 116 can include, for example, an AC/DC converter, a transformer, a voltage regulator and other electronics depending on the electrical characteristics of one or more potential external power source 118. The external power source 118 supplies an electrical current 120 to the electrolyzer 102 (electrolysis unit) which causes the water 114 to decompose into hydrogen 110 and oxygen 111. During the generation of hydrogen 110 and oxygen 111, the water 114 is consumed. Thus, the water 114 which is preferably de-ionized water needs to be replaced within the electrolyzer 102. The user can use an opening 114a in the electrolyzer 102 to add water 114. The generated hydrogen 110 is transferred to and stored within the hydrogen storage unit 104.

The hydrogen storage unit 104 in the preferred embodiment can be a metal hydride storage vessel 104 that contains LaNi₅H₆ metal hydride (for example). The metal hydride storage vessel 104 is able to absorb hydrogen 110 that is generated by the electrolyzer 102 and then release the stored hydrogen 110 to the SPE fuel cell 106. The total amount of hydrogen 110 absorbed and stored in the metal hydride storage vessel 104 is generally 2-3% and can even be upto 6% of the total weight of the metal hydride storage vessel 104. The life of the metal hydride storage vessel 104 is directly related to the purity of the hydrogen 110 generated by the electrolyzer 102. Because, the metal alloys in the metal hydride storage vessel 104 not only absorb hydrogen 110 but they also absorb impurities introduced by the hydrogen 110. The absorption of impurities reduces the ability of the metal hydride storage vessel 104 to store hydrogen 110 since the impurities left behind fill the spaces in the metal alloys once reserved for hydrogen 110. Alternatively, the hydrogen storage vessel 104 can contain carbon black, graphite, activated carbon, carbon nanotube or any other hydrogen absorbing/adsorbing material that can reversibly store hydrogen.

The hydrogen storage unit 104 can also include a connector 122 which enables the interface with a second hydrogen delivery/supply unit 124. The second hydrogen delivery/supply unit 124 in the preferred embodiment is a regulated high-pressure hydrogen storage cylinder 124 or it can be any other source of hydrogen that has a suitable purity and pressure. For example, it is believed that a hydrogen infrastructure is going to evolve over time such that hydrogen outlets are going to be found in numerous public places. The hydrogen storage cylinder 124 is attachable to and detachable from a connector 122 in the hydrogen storage unit 104. The hydrogen storage cylinder 124 is generally used when the first hydrogen generation unit 102 is not operable or the user cannot find a suitable external power source 118 to recharge the hydrogen storage unit 104.

The SPE fuel cell 106 utilizes the hydrogen 112 stored in the hydrogen storage unit 104 and oxygen 126 from the air to generate electricity 128. Typically, the SPE fuel cell 106 is able to generate around 0.5-60 Watts or more of power which is enough electricity 128 to power a wide-range of portable electrical devices 112 (e.g., cell phones, personal digital assistants, laptop computers, flashlights). The portable fuel cell system 100 and in particular the SPE fuel cell 106 may not be activated to generate electricity 128 unless the electrical device 112 is turned-on. Alternatively, the portable fuel cell system 100 can be turned-on and turned-off by the user interacting with a power switch 123 shown located on the hydrogen storage unit 102 but could also be located on the hydrogen generation unit 102 or the fuel cell 106.

The SPE fuel cell 106 in principle is like a battery. However, the SPE fuel cell 106 does not run down or require recharging like a battery. Instead, the SPE fuel cell 106 produces energy in the form of electricity 128 and heat as long as it is supplied with hydrogen 110 (e.g., fuel). As shown, the SPE fuel cell 106 includes two electrodes 130 and 132 sandwiched around an electrolyte 134. The SPE fuel cell 106 generates electricity 128 when oxygen/air 126 is passed over the cathode catalyst electrode 130 and hydrogen 110 is passed over the anode catalyst electrode 132. In particular, the hydrogen 110 is split into an electron “e⁻” and a proton “H⁺” with the aid of the anode catalyst electrode 132. The electron “e⁻” travels on wires 137 while the proton “H⁺” passes through the electrolyte 134. The electrons “e⁻” create the electricity 128 that is utilized by the portable electrical device 112 before the electrons “e⁻” reach the cathode catalyst electrode 130 to be reunited with the protons “H⁺” and oxygen/air 126 to form water 136. If desired this water 136 can be used to replace the water 114 in the hydrogen generation unit 102.

Even though the portable fuel cell system 100 described above uses the SPE fuel cell 106, it should be understood that different types of fuel cells can be used such as alkaline fuel cells, phosphoric acid fuel cells and solid oxide fuel cells. The SPE fuel cell 106 has favorable characteristics such as fast load following and an ability to operate at low temperatures which makes it the preferred fuel cell in the present invention.

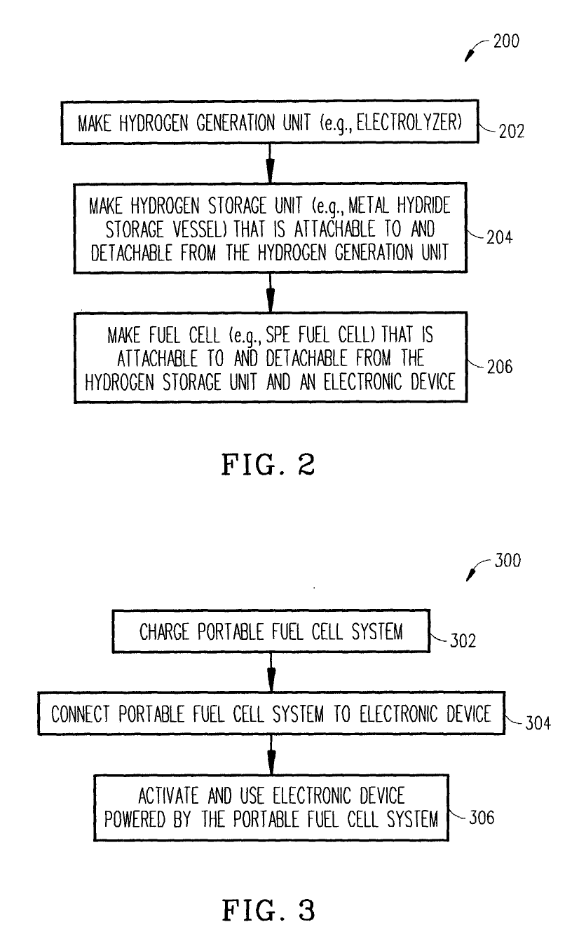

Referring to FIG. 2, there is a flowchart illustrating the steps of a preferred method 200 for making the portable fuel cell system 100 in accordance with the present invention. Beginning at steps 202 and 204, the manufacturer would make the hydrogen generation unit 102 (i.e., electrolyzer 102) and the hydrogen storage unit 104 (e.g., metal hydride storage vessel 104) so that they are operatively connected to one another. In the preferred embodiment, the hydrogen generation unit 102 and the hydrogen storage unit 104 are attachable to and detachable from one another using a pair of connectors 108a (e.g., snap-fit connectors, pin-slot connectors, screw/nut connectors). In addition, the hydrogen storage unit 104 can be manufactured to include another connector 122 which is designed to interface with a second hydrogen delivery/supply unit 124 (e.g., regulated high-pressure hydrogen storage cylinder 124).

At step 206, the manufacturer would make the fuel cell 106 (e.g., SPE fuel cell) so that it is operatively connected to the hydrogen storage unit 104. In the preferred embodiment, the fuel cell 106 and the hydrogen storage unit 104 are attachable to and detachable from to one another using a pair of connectors 108b (e.g., snap-fit connectors, pin-slot connectors, screw/nut connectors). The SPE fuel cell 106 is also made to be attachable to and detachable from the portable electrical device 112 using a pair of connectors 108c. The connectors 108c can be the same as or similar to connectors 108a and 108b. As described above, the portable electrical device 112 can include, for example, a cell phone, a personal digital assistant, a laptop computer, a digital camera, a game device, a portable television, a small heater, a flashlight or other small electrical device.

Referring to FIG. 3, there is a flowchart illustrating the steps of a preferred method 300 for using the portable fuel cell system 100 in accordance with the present invention. Beginning at step 302, the user typically charges or recharges the portable fuel cell system 100 and in particular the hydrogen storage unit 104 with hydrogen 110 by plugging a cable 118a extending from the hydrogen generation unit 102 into the external power source 118 (see FIG. 1). The cable 118a is detachably connected to the hydrogen generation unit 102 and the external power source 118. Once the hydrogen storage unit 104 is properly charged or recharged, the user can disconnect the hydrogen generation unit 102 from the external power source 118. Alternatively, the user can charge or recharge the portable fuel cell system 100 by connecting the hydrogen storage unit 104 to the second hydrogen delivery/supply unit 124 (e.g., hydrogen storage cylinder 124). In yet another option, the user can charge or recharge the portable fuel system 100 by disconnecting an empty hydrogen storage unit 104 and replacing it with a charged hydrogen storage unit 104. The portable fuel cell system 100 can have one or more indication lights 121 which inform the user when the hydrogen storage unit 104 is full or needs to be filled with hydrogen 110 (see FIG. 1). At this point, the portable fuel cell system 100 is ready to be used.

At step 304, the user connects the portable fuel cell system 100 and in particular the SPE fuel cell 106 to a portable electrical device 112 (e.g., cell phone, PDA, laptop computer, digital camera, game device, portable television, flashlight). Then at step 306, the user activates and uses the portable electrical device 112 which is powered by the portable fuel cell system 100. It should be noted that the user can plug the hydrogen generation unit 102 into the external power source 118 while they are using the electrical device 112 in order to recharge the hydrogen storage unit 104.

In another embodiment of the present invention, the portable fuel cell system 100 can include only the hydrogen generation unit 102 and the hydrogen storage unit 104. In this case, the portable electrical device 112 could include its own fuel cell 106 which would interface with the combined hydrogen generation unit 102 and the hydrogen storage unit 104.

Although several embodiments of the present invention has been illustrated in the accompanying Drawings and/or described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. A portable fuel cell system, comprising:
a hydrogen generation unit;
a hydrogen storage unit including a connector that enables said hydrogen storage unit to be attachable to and detachable from a connector in said hydrogen generation unit; and
a fuel cell including a connector that enables said fuel cell to be attachable to and detachable from another connector in said hydrogen storage unit.

2. The portable fuel cell system of claim 1, wherein said hydrogen generation unit is an electrolyzer.

3. The portable fuel cell system of claim 1, wherein said hydrogen generation unit includes at least one electrical component that interfaces with an external power source.

4. The portable fuel cell system of claim 3, wherein said external power source is a household power outlet, a car power outlet, a solar panel, a battery or another fuel cell.

5. The portable fuel cell system of claim 1, wherein said hydrogen storage unit is a metal hydride storage vessel.

6. The portable fuel cell system of claim 1, wherein said hydrogen storage unit is a vessel with a material capable of reversibly storing hydrogen such as carbon black, graphite, activated carbon, or carbon nanotube.

7. The portable fuel cell system of claim 1, wherein said hydrogen storage unit includes yet another connector that enables said hydrogen storage unit to be attachable to and detachable from a second hydrogen delivery/supply unit.

8. The portable fuel cell system of claim 7, wherein said second hydrogen delivery/supply unit is a regulated high-pressure hydrogen storage cylinder.

9. The portable fuel cell system of claim 1, wherein said fuel cell is a solid polymer electrolyte (SPE) fuel cell that generates between 0.5-60 watts of electricity.

10. The portable fuel cell system of claim 1, wherein said fuel cell is an alkaline fuel cell, a phosphoric acid fuel cell or a solid oxide fuel cell that generates between 0.5-60 watts of electricity.

11. The portable fuel cell system of claim 1, wherein said fuel cell includes another connector that enables said fuel cell to be attachable to and detachable from an electrical device.

12. The portable fuel cell system of claim 11, wherein said electrical device is a cell phone, a personal digital assistant, a laptop computer, a digital camera, a game device, a portable television, a small heater, or a flashlight.

13. A method for making a portable fuel cell system, said method comprising the steps of:
making a hydrogen generation unit;
making a hydrogen storage unit that includes a connector which enables said hydrogen storage unit to be attachable to and detachable from a connector in said hydrogen generation unit; and
making a fuel cell including a connector that enables said fuel cell to be attachable to and detachable from another connector in said hydrogen storage unit.

14. The method of claim 13, wherein said hydrogen generation unit includes at least one electrical component that interfaces with a household power outlet, a car power outlet, a solar panel, a battery or another fuel cell.

15. The method of claim 13, wherein said hydrogen storage unit is manufactured to have yet another connector that enables said hydrogen storage unit to be attachable to and detachable from a second hydrogen delivery/supply unit.

16. The method of claim 13, wherein said fuel cell is manufactured to have a connector that enables said fuel cell to be attachable to and detachable from an electrical device.

17. The method of claim 13, wherein:
said hydrogen generation unit is an electrolyzer;
said hydrogen storage unit is a storage vessel containing metal hydride, carbon black, graphite, activated carbon, carbon nanotube or any other hydrogen absorbing/adsorbing material; and
said fuel cell is a solid polymer electrolyte (SPE) fuel cell, an alkaline fuel cell, a phosphoric acid fuel cell or a solid oxide fuel cell.

18. A method for using a portable fuel cell system, said method comprising the steps of:
connecting said portable fuel cell system to an electrical device, said portable fuel cell system includes:
a hydrogen generation unit;
a hydrogen storage unit that is attachable to and detachable from said hydrogen generation unit; and
a fuel cell that is attachable to and detachable from said hydrogen storage unit; and
activating said electrical device which is powered by said portable fuel cell system.

19. The method of claim 17, further comprising the step of charging or recharging the hydrogen storage unit.

20. The method of claim 17, wherein said electrical device is a cell phone, a personal digital assistant, a laptop computer, a digital camera, a game device, a portable television, a small heater, or a flashlight.

21. The method of claim 17, wherein:
said hydrogen generation unit is an electrolyzer;
said hydrogen storage unit is a storage vessel containing metal hydride, carbon black, graphite, activated carbon, carbon nanotube or any other hydrogen absorbing/adsorbing material; and
said fuel cell is a solid polymer electrolyte (SPE) fuel cell, an alkaline fuel cell, a phosphoric acid fuel cell or a solid oxide fuel cell.

22. The method of claim 17, wherein said hydrogen generation unit includes at least one electrical component that interfaces with a household power outlet, a car power outlet, a solar panel, a battery or another fuel cell.

23. The method of claim 17, wherein said hydrogen storage unit is also attachable to and detachable from a second hydrogen delivery/supply unit.

24. The method of claim 23, wherein said second hydrogen delivery/supply unit is a regulated high-pressure hydrogen storage cylinder.

25. A portable fuel cell system, comprising:
a fuel generation unit; and
a fuel storage unit including a connector that enables said fuel storage unit to be attachable to and detachable from a connector in said fuel generation unit.

26. The portable fuel cell system of claim 25, further comprising a fuel cell including a connector that enables said fuel cell to be attachable to and detachable from another connector in said fuel storage unit.

27. The portable fuel cell system of claim 26, wherein said fuel cell includes another connector that enables said fuel cell to be attachable to and detachable from an electrical device.

28. The portable fuel cell system of claim 27, wherein said electrical device includes a cell phone, a personal digital assistant, a laptop computer, a digital camera, a game device, a portable television, a small heater, or a flashlight.
